(19) United States
(12) Patent Application Publication
(10) Pub. No.: US 2009/0007738 A1
(43) Pub. Date: Jan. 8, 2009

(54) Method and tool for producing a press joint connection

(75) Inventor: Eugen Rapp, Berg (DE)

Correspondence Address: JORDAN AND HAMBURG LLP, 122 EAST 42ND STREET, SUITE 4000, NEW YORK, NY, 10168, US

(73) Assignee: TOX Pressotechnik GmbH & Co. KG, Weingarten (DE)

(21) Appl. No.: 12/214,369

(22) Filed: Jun. 17, 2008

Related U.S. Application Data
(63) Continuation of application No. 10/257,041, filed on Feb. 21, 2003, now abandoned.

(30) Foreign Application Priority Data
Apr. 5, 2000 (DE) 100 16 780.2

(51) Int. Cl. B26D 5/00; B23P 11/00

(52) U.S. Cl. 83/373; 29/525.11

(57) ABSTRACT

The invention relates to a method and tool for producing a press joint connection. According to the invention, portions of the radial lateral walls of the matrix opening (3) are configured as flexible displaceable segments, whereas other sections (5), when viewed from the periphery of the matrix opening (3), remain rigidly connected to the die.

### TECHNICAL STATUS

The invention consists of a method of connecting construction parts such as plates, bolts, nut, etc. with a plate by using a press joint connection of a type based on the primary claim or a tool based on the title of secondary claim 4.

In one recognized method based on the same type (DE-05 35 32 900), the material that is displaced from the plate into the lower die opening flows outward in a radial motion to the walls of lower die opening because of the base of the lower die, whereby the displaced material grips the rim of the opening produced by the die and therefore creates a solid connection between the construction element and the plate. This method of connection is normally called a press joint connection. It can be used for connecting two or more stacked plates or for connecting bolts etc. to one or more plates whereby the so-called lost die that is used is either made of soft formable material which is hard enough to perform one press through the plate or to make the corresponding radial cavity within which the displaced plate material can be formed.

The disadvantage of this extremely quick and precise press joint connection with a lower die having inflexible restricting walls is that it leads to connection points having a limited elasticity.

### THE INVENTION AND ITS ADVANTAGES

The method based on the invention with the characterizing features of the primary claim and the tool based on the invention with its characterizing features from claim 4 have the advantage that at a high degree of functionality security, a higher elasticity connection is made in manufacturing the connection point between equal segments so that the final technical shear and head traction values are higher than for the connection points mentioned above. The elasticity that is achieved is advantageous in that the ability to work using the method and the tool are retained.

Along with the tool, there is also the advantage that the flexible radial segments that flow outward always land back in their original positions after the operating cycle. There are tools that are recognized which have the radial restricting walls of the lower die made of flexible sections (DE-OS 44 35 460 and DE-GM 297 00 868) but these have the disadvantage that all sections are positioned flexibly so that remnants of the processed material can get caught in between the individual sections in such a way that the sections can no longer return to their original positions, thus decreasing the ability to produce the required connection quality.

Based on an advantageous version of the method based on the invention, the distribution of the radial resistance in reference to the circumference of the lower die opening is centrally symmetrical. This achieves even strength on the connection points.

Another advantageous version of the invention supplements the press joint connection with adhesive elements.

Another advantageous version of the invention as a tool according to secondary claim 4, the segment height matches the depth of the sack opening which ensures that the base of the sack opening remains at its own level even with the enlarged sack opening caused by the flexed segmentation.

In another version of the invention the volume of the material to be displaced in the initial position (before the assembly procedure) is a bit more than the volume of the sack opening minus the intrusion volume of the form die. The extra volume causes radial movement of the segments.

In another version of the invention, the segments can move against a tension force. The tension can be created in different ways but the main thing is that the segments return to their original positions after the work procedure and the return of the die or the removal of the connection point from the lower die opening.

In another version of the invention, the segments are fed into cavities which run into the same level as the base of the sack opening and have guide bands on the sides which run in the radial movement direction of the segments. Any remaining material is pushed back and discarded with this method without any danger of it being pushed into a gap or reducing the functionality.

Based on another version of the invention, the opposing guide walls of the segments run parallel to inflexible wall segments.

Another version of the invention has leaf or bar springs for tension on the die. Besides this type of spring being easy to implement and secure in their functionality, they take up a minimum amount of space.

In another version of the invention the segments are run in grooves of the die which results in the ability to decrease the radial dimensions.

In a further version of the invention the springs on the far end of the segments are connected together as one piece over a connecting section whereby there is an offset of the same in the junction section between the connecting section and the springs, in the direction of the casing parts. This allows the segments to connect together better and the spring system is extremely economical to manufacture. There is also a very significant reduction in the danger of breakage's occurring or other kinds of breakdown.

In a further relevant advantageous version of the invention the connecting section is located in a jointing section of the lower die which runs transverse to the direction of the drive and which allows the connecting section to be permanently integrated into the lower die.

In a further version of the invention this connecting section is made in a cross or star form depending on how many springs must be connected together.

In a further version of the invention there are grooves made in a longitudinal direction and/or on the face side in the mould parting section to receive the springs and/or the connecting section. This allows one to obtain an assembly as a lower die which is self-contained and therefore more easily installed and removed. Another advantage not even mentioned yet is reduction of damage due to external interventions.

Further advantages and advantageous versions of the invention can be taken from the following description, drawing and claims.

### BRIEF DESCRIPTION OF THE DRAWINGS

One embodiment of the invention in a variety of versions is shown in the drawing and will be described in more detail below. This shows:

FIG. 1 the tool in an exploded diagram and in a part-section drawing according to I in FIG. 2,

FIG. 2 a part-section drawing according to II-II in FIG. 1,

FIGS. 3-5 versions of the example embodiment of the invention

### DESCRIPTION OF THE PREFERRED EMBODIMENTS

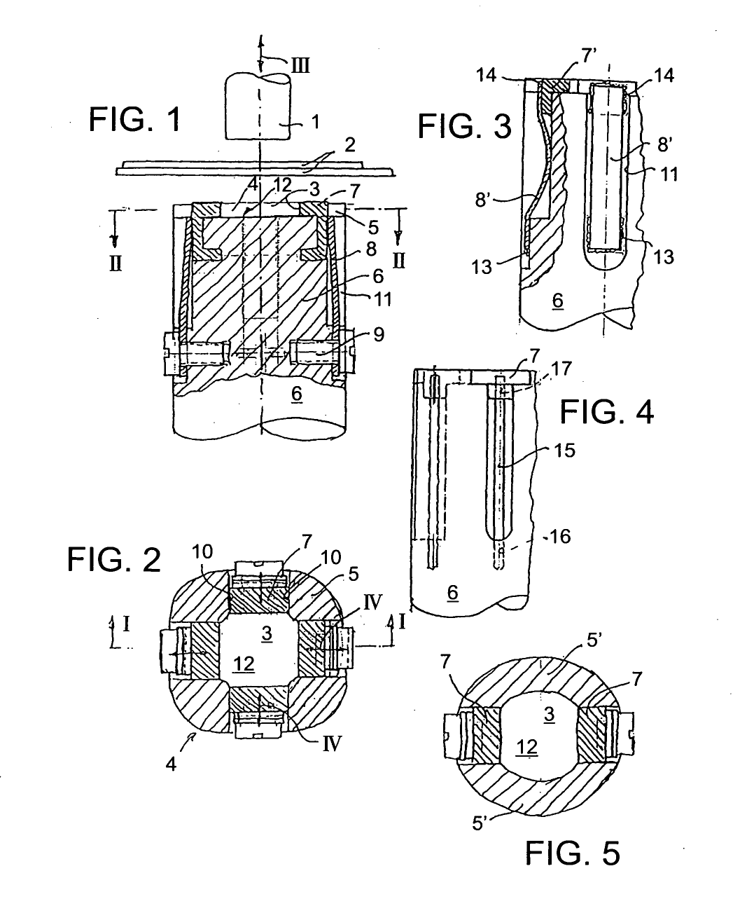

FIG. 1 shows an exploded diagram of a novel tool that is a punch 1 which can be actuated according to Arrow III over the range of its working stroke and is capable of pressing the two opposing plates 2 into the opening 3 of a die 4. The die consists of the fixed sections 5 of a forging die 6 as well as the segments 7 which can be moved axially outwards and which are actuated by leaf springs 8 in the starting position as shown. The leaf springs 8 are fixed to the forging die 6 over screws 9 and are located in a longitudinal groove of the forging die 6. The opening 3 is limited at its bottom by a base 12 which is created by the forging die 6.

As shown in FIG. 2, the segments 7 between the fixed sections 5 of the forging die 6 can be moved radially, guided by the guide walls 13 on the fixed sections 5 of the forging die. Movement causes segments 7 to slide over the base 12 of the blind opening 3.

This movement causes segments 7 to be moved according to the displacement stroke IV. The press joint connection is achieved in that the plates 2 are laid on the die 6, the corresponding parts of the surface pressed deeply into the blind opening 3 down to the bottom of the opening 12 by the punch 1 and then squashed together, so that the material is pushed radially outwards to the fixed sections 5 as well as segments 7 which form the radial wall of the blind opening 3. While the displaced material is held back by the fixed sections 5 of the die 4, the material in-between is displaced against the movable segments which give 5o that the material can flow after them. This, as described at the beginning, is how a differing structure of the connecting point is created.

FIG. 3 shows a version of the example embodiment of the invention in which the leaf spring 8 is welded to the die at 13 and the segment. This creates a fixed connection, most importantly that of the segment 7 to the tool.

FIG. 4 shows a second version of this example, embodiment of the invention where a spring-pin 15 is used instead of a leaf spring 8 and is placed inside corresponding bore holes 16 of the die 6 or 17 of the segment 7.

While the object shown in FIG. 2 has 4 segments 7 the version shown in FIG. 5 only has two such movable segments 7. The fixed sections 5 of this lower die are made wider accordingly and the structure of the connecting node is also correspondingly different.

All of the embodiments described in the following claims and drawing can be used on their own or in any desired combination with each other in a novel fashion.

### LIST OF REFERENCE NUMBERS

1 Punch
2 Plates
Opening
4 Lower die
Sections
Die
7 Segment
8 Leaf spring
9 9 Screws
10 Wall openings
11 Longitudinal groove
12 Bottom
13 Weld
14 Weld
15 Spring-pin
16 Bore hole
17 Bore hole
I Cut-out in FIG. 2
II Cut-out in FIG. 1
III Working stroke
IV Displacement stroke

1.-15. (canceled)

16. A method of forming a pressed joint connection of components which include at least one plate, comprising:
interposing said components between an end of a punch and a die opening of a die leading into a die chamber;
advancing said punch along an advancement axis through the die opening of the die chamber to draw said components into said die opening, said chamber being bounded by circumferentially spaced elastically yielding movable wall segments which are movable in a radial direction of said advancement axis against radially inward biasing and fixed wall segments circumferentially disposed between said movable wall segments which are secured against movement in said radial direction, and by a base arranged crosswise to said advancement axis and opposite to said opening; and
causing material of the components drawn into said opening to flow radially outward by axial compression thereof against said base of the die chamber created by continued advancing of the punch thereby radially displacing said elastically yielding wall segments against said inward biasing and being stopped by said fixed wall segments circumferentially therebetween, said base being configured to extend radially outward of said advancement axis to at least a position corresponding to a maximum distance of radial displacement of the movable wall segments caused by material flow acting against the radially inward biasing, such that the material being drawn by said advancing and said continued advancing is fully supported by the base over an entirely of said radial displacement of the joined material in a region of each of the movable wall segments.

17. A method according to claim 16, wherein a distribution of radial resistance relative to a circumference of the die opening is centrally symmetrical.

18. A method according to claim 16, further comprising introducing adhesive between said components prior to said advancing to supplement said press joint connection.

19. A method according to claim 16, wherein at least one plate includes at least two plates which are connected as overlaying one another.

20. A method according to claim 16, wherein said base is formed by a forging die located in a position adjacent to said die in a direction of said advancement axis.

21. A tool for forming a press joint connection of components which include at least one plate, comprising:
a punch advanceable along an advancement axis; and
a die including a die chamber having an opening, an interior of said die clamber being bounded by circumferentially spaced elastically yielding movable wall segments which are movable in a radial direction of said advancement axis against a radially inward biasing and fixed wall segments circumferentially disposed between said movable wall segments which are secured against movement in said radial direction, and by a base arranged crosswise to said advancement axis and opposite to said opening;
said punch being advanceable into said opening of said die along said advancement axis, said components being positionable between said punch and said opening, such that material of the components is drawn into said opening by advancement of said punch into said opening and is caused to flow radially outward by axial compression thereof against said base of the die chamber by continued advancement of the punch, thereby radially displacing said elastically yielding wall segments against said inward biasing and being stopped by said fixed wall segments circumferentially therebetween, said base being configured to extend radially outward of said advancement axis to at least a position corresponding to a maximum distance of radial displacement of the movable wall segments caused by material flow acting against the radially inward biasing, such that the material being drawn by said advancement of the punch is fully supported by the base over an entirely of said radial displacement of the joined material in a region of each of the movable wall segments.

22. A tool according claim 21, a height of the elastically yielding wall segments is the same as a depth of the die chamber from the opening to the base.

23. A tool according claim 21 wherein a volume of the material at a starting point before a press joint connection process begins is greater than a corresponding volume of the die chamber without radial displacement of said movable wall segments minus a punch volume of a portion of the punch receivable in the die chamber.

24. A tool according to claim 21, further comprising a spring against which the movable wall segments are radially movable.

25. A tool according to claim 24, wherein the movable wall segments are at least partially received in wall openings which run in the radial sliding direction of the segments, said wall openings being laterally defined by guide walls on a same level as said base.

26. A tool according to claim 24, wherein said spring includes a leaf spring or spring-pin located on the die.

27. A tool according to claim 26, wherein:
the die includes at least one longitudinal groove; and
said at least one spring is guided in said at least one longitudinal groove.

28. A tool according to claim 26, wherein:
said at least one spring includes springs;
the springs on a base end of the segments are connected together as one piece over a connecting section; and
there is an offset of a same amount in a junction section between the connecting section and the springs in a direction of the movable wall segments.

29. A tool according to claim 28, wherein:
said base is formed by a forging die located in a position adjacent to said die in a direction of said advancement axis; and
the connecting section is located in a jointing section of the forging die which runs transverse to the advancement axis.

30. A tool according to claim 28, wherein the connecting section is in a form of a cross or a star.

31. A tool according to claim 28, wherein grooves are provided in a longitudinal direction and/or in a bottom section of the forging die to receive springs and/or the connecting section.

32. A tool according to claim 21, wherein said circumferentially spaced elastically yielding movable wall segments include two movable wall segments disposed in circumferentially opposed positions.

33. A tool according to claim 21, wherein said circumferentially spaced elastically yielding movable wall segments include four movable wall segments disposed symmetrically arranged circumferential positions.
